(19) United States
(12) Patent Application Publication
(10) Pub. No.: US 2026/0162069 A1
(43) Pub. Date: Jun. 11, 2026

(54) CONTEXTUAL TITLES FOR CALENDAR INVITES

(71) Applicant: Motorola Mobility LLC, Chicago, IL (US)

(72) Inventors: Amit Kumar Agrawal, Bangalore (IN); Krishnan Raghavan, Bangalore (IN); Nakul Patel, Bangalore (IN)

(73) Assignee: Motorola Mobility LLC, Chicago, IL (US)

(21) Appl. No.: 18/976,658

(22) Filed: Dec. 11, 2024

(51) Int. Cl. G06Q 10/1093

(52) U.S. Cl. CPC G06Q 10/1093

(57) ABSTRACT

In aspects of contextual titles for calendar invites, a mobile device includes memory to maintain calendar data and at least one processor coupled with the memory. The processor causes the mobile device to receive a calendar invite of the calendar data with meeting details that include one or more of attendees, a title, or an agenda. The processor further causes the mobile device to determine an alternative title for the calendar invite using a machine-learning model based at least on a context determined using the meeting details. The alternative title is then displayed via a user interface on a mobile device display.

### BACKGROUND

As technology advances, electronic devices have become an integral part of our daily lives, making it easier for people to attend meetings and manage various tasks. Many individuals now have multiple work and personal meetings and responsibilities each day, often conducted using teleconference applications. Additionally, the increase in remote work and non-traditional work hours has led to a growing number of meetings that people participate in. Calendar invites have become a common tool to schedule and manage such meetings, events, and tasks for professional and personal settings. When integrated within email and communication platforms, these calendar invites can provide a centralized organization of a user's commitments.

### BRIEF DESCRIPTION OF THE DRAWINGS

Implementations of the techniques for generating contextual titles for calendar invites are described with reference to the following Figures. The same numbers may be used throughout to reference like features and components shown in the Figures.

FIG. 1 illustrates an example system for generating contextual titles for calendar invites in accordance with one or more implementations as described herein.

FIG. 2 further illustrates an example system in which aspects of generating contextual titles for calendar invites can be implemented in accordance with one or more implementations as described herein.

FIG. 3 illustrates an example flow diagram in which aspects of generating contextual titles for calendar invites can be implemented.

FIG. 4 illustrates an example method for generating contextual titles for calendar invites in accordance with one or more implementations of the techniques described herein.

FIGS. 5A and 5B illustrate example user interfaces with calendar invites in which aspects of generating contextual titles for calendar invites can be implemented.

FIG. 6 illustrates various components of an example device that may be used to implement the techniques for contextual titles for calendar invites as described herein.

### DETAILED DESCRIPTION

Implementations of the techniques for contextual titles for calendar invites may be implemented as described herein. A mobile device, such as any type of a wireless device, media device, mobile phone, flip phone, client device, tablet, computing, communication, entertainment, gaming, media playback, and/or any other type of computing and/or electronic device, or a system of any combination of such devices, may be configured to perform techniques for contextual titles for calendar invites as described herein. In one or more implementations, a mobile device includes a title recommendation module, which can be used to implement aspects of the techniques described herein.

Calendar invites have emerged as a common tool for efficiently scheduling and managing meetings, events, and tasks across both professional and personal contexts. Calendar invites are often seamlessly integrated into popular email and communication platforms to provide users a centralized system to organize a variety of commitments. A typical calendar invite includes several details, such as the date and time of the event, the location (e.g., a physical venue or a virtual meeting link), a list of attendees, a title, and/or an agenda. By including such elements, calendar invites facilitate clear communication among participants and enhance overall coordination and engagement.

The rise of remote work and global collaboration has increased and emphasized the significance of effective scheduling tools. Calendar invites minimize miscommunication among team members and avoid scheduling conflicts, offering features such as automatic reminders, alerts, and real-time updates that enhance coordination among teams across different locations and various time zones. Calendar invites also facilitate easy rescheduling and/or cancellations, ensuring that participants receive timely notifications. The ability to attach relevant documents, links, or notes further enriches the functionality of the calendar invites, enabling a comprehensive approach for users to prepare for and participate in meetings and events. The integration of calendar invites into users' daily lives represents a substantial improvement in time management and collaboration, allowing individuals and teams to navigate their schedules with greater ease and efficiency.

However, the naming or title of calendar invites can often be confusing, especially for individuals with busy schedules. Misleading or vague titles can create several issues, making it difficult for participants to quickly take note of understand the purpose, focus, and/or topic of a meeting. This lack of clarity often leads to misunderstandings, insufficient preparation time, and inefficiency. For example, common titles may be interpreted differently depending on a participant's role or knowledge. Vague titles like “One on one” or “Sync” do not specify who is attending the meeting or its intended focus. Similarly, misleading or generic titles fail to provide sufficient context, leaving attendees uncertain about the agenda or its relevance. When meetings are forwarded, changes to an agenda can occur without updating the title, causing further confusion. As a result, participants find it difficult to prioritize meetings when titles are vague, sometimes leading to conflicts or missed information. In addition, this ambiguity can disrupt workflows and decrease the effectiveness of scheduled meetings.

Consider a scenario where Chris manages a large team and frequently collaborates with various peers and senior stakeholders, filling his calendar with back-to-back meetings. Each week, Chris navigates a whirlwind of one-on-one meetings, team discussions, and strategy sessions. However, the inconsistent naming conventions used by his colleagues creates a maze of confusion. One minute, he is preparing for a “Sync,” which can mean anything from project updates to casual check-ins. Occasionally, someone forwards a meeting titled “Weekly Review,” but the agenda may suddenly shift to urgent discussions about budget cuts. Chris often finds himself scrambling to determine who is leading each discussion and what the main focus is, wasting valuable time.

As he stares at his calendar filled with ambiguous titles, Chris wishes for improved clarity on what his day will look like. With each accepted calendar invite, the dread of an unclear agenda looms larger, making Chris wonder how he can stay on top of his responsibilities.

To address such scenarios, many organizations try to enforce standardized templates for meeting titles and agendas. The effectiveness of such efforts, however, is limited by how often and appropriately users adopt such templates. Another conventional approach focuses on context-specific user interfaces for calendar applications. For example, this conventional approach dynamically alters a user interface based on the time of day or other context, incorporating visual elements like images and reflections that change with time. The user interface may include time indicators and other affordances for interacting with applications.

In contrast to the visual reflection and image manipulation techniques used in the described conventional approach, the described techniques for creating contextual titles focus on calendar management and refining meeting titles. Specifically, natural language processing techniques are employed to add descriptive annotations to non-descriptive meeting invitations, calendar events, and notifications. These annotations are generated using various data sources, such as meeting details, emails, chats, and documents, to enhance the descriptiveness of the titles. This approach allows users to receive personalized meeting and event titles, leading to better preparedness and improved efficiency.

In aspects of the described techniques, a mobile device implements a title recommendation module to parse calendar information and provide meeting titles and details to a natural language processing module. The natural language processing module processes the meeting details to extract key information, such as attendees and an agenda. Based on the key data, topics, and themes for the meeting are determined by the natural language processing module using semantic analysis and entity recognition. The natural language processing module can also obtain data from external sources (e.g., emails, chats, and documents) and data corresponding to a user's personal knowledge base to refine the context for each meeting invite. A suggested title is then added in a calendar or other user interface based on the context analysis.

While features and concepts of the described techniques for contextual titles for calendar invites are implemented in any number of different devices, systems, environments, and/or configurations, implementations of the techniques for contextual titles for calendar invites are described in the context of the following example devices, systems, and methods.

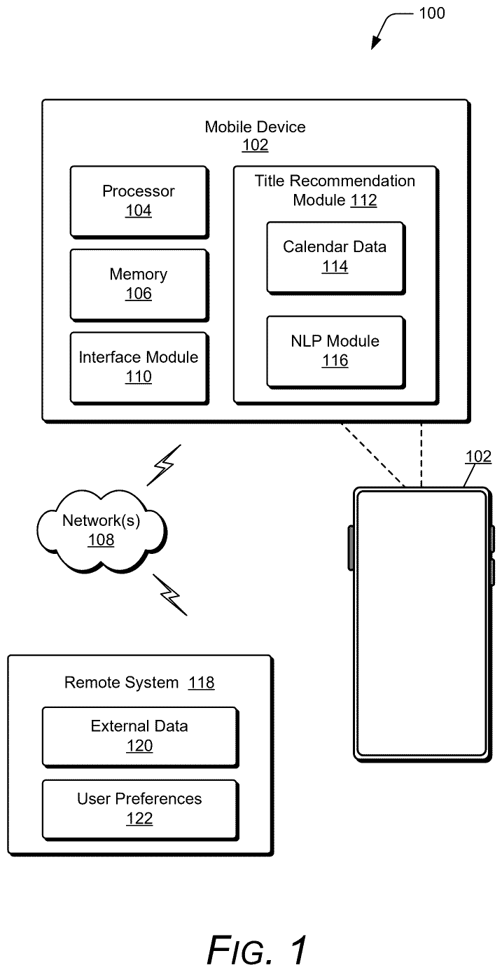

FIG. 1 illustrates an example system 100 for generating contextual titles for calendar invites, as described herein. The system 100 includes a mobile device 102. Examples of mobile device 102 include at least one of any type of a wireless device, mobile device, mobile phone, flip phone, client device, companion device, tablet, computing device, communication device, entertainment device, gaming device, media playback device, any other type of computing and/or electronic device.

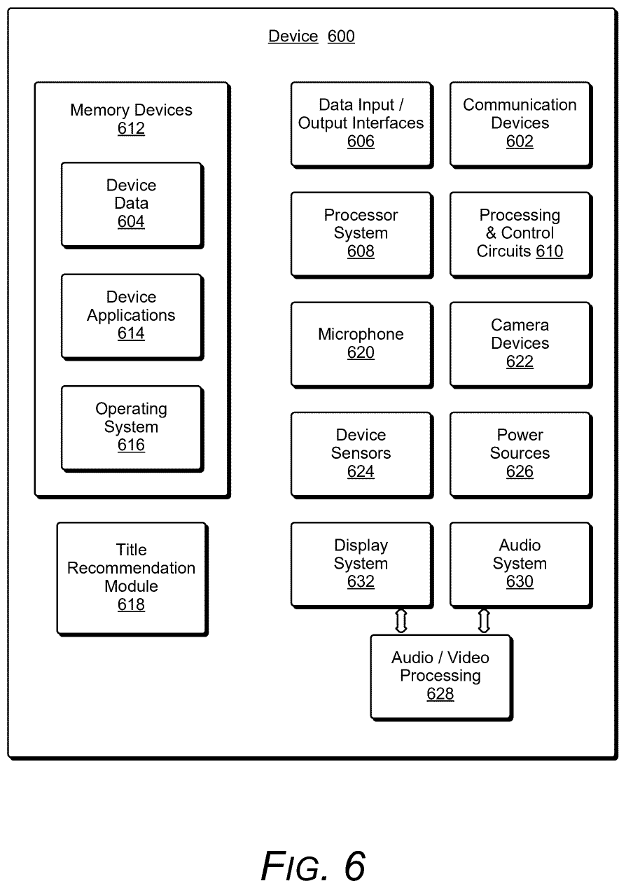

The mobile device 102 can be implemented with various components, such as the processor 104 and memory 106, as well as any number and combination of different components as further described with reference to the example device shown in FIG. 6. In implementations, the mobile device 102 includes various radios for wireless communication with other devices. For example, the system and devices can include a Bluetooth (BT) and/or Bluetooth Low Energy (BLE) transceiver, as well as a near-field communication (NFC) transceiver. In some cases, the system 100 and mobile device 102 include at least one WiFi radio, a cellular radio, a global positioning satellite (GPS) radio, or any available type of device communication interface.

In some implementations, the devices, applications, modules, servers, and/or services described herein communicate via one or more communication networks 108, such as for data communication with the mobile device 102. The communication network 108 includes a wired and/or wireless network. The communication network 108 is implemented using any type of network topology and/or communication protocol and is represented or otherwise implemented as a combination of two or more networks, including IP-based networks, cellular networks, and/or the Internet. The communication network 108 includes mobile operator networks managed by a mobile network operator and/or other network operators, such as a communication service provider, mobile phone provider, and/or Internet service provider.

Mobile device 102 includes various functionalities enabling the device to generate contextual titles for calendar invites, as described herein. In one or more examples, an interface module 110 represents functionality (e.g., logic and/or hardware) enabling the mobile device 102 to interconnect and interface with other devices and/or networks, such as the communication network 108. For example, the interface module 110 enables wireless and/or wired connectivity of the mobile device 102.

The mobile device 102 can include and implement various device applications, such as any type of calendar application, messaging application, email application, video communication application, cellular communication application, music/audio application, gaming application, media application, social platform applications, and/or any other of the many possible types of various device applications. Many of the device applications have an associated application user interface that is generated and displayed for user interaction and viewing, such as on a display screen of the mobile device 102. Generally, an application user interface, or any other type of video, image, graphic, and the like is digital image content that is displayable on the display screen of the mobile device 102.

In the example system 100 for generating contextual titles for calendar invites, the mobile device 102 implements a title recommendation module 112 (e.g., as a device application or as a portion of a calendar or email application). As shown in this example, the title recommendation module 112 represents functionality (e.g., logic, software, and/or hardware) enabling aspects of the described techniques for generating contextual titles for calendar invites. The title recommendation module 112 can be implemented as computer instructions stored on computer-readable storage media (e.g., memory 106) and can be executed by a processor system (e.g., the processor 104) of the mobile device 102. Alternatively, or in addition, the title recommendation module 112 can be implemented at least partially in the device's hardware.

In one or more implementations, the title recommendation module 112 includes independent processing, memory, and/or logic components functioning as a computing and/or electronic device integrated with the mobile device 102. Alternatively, or in addition, the title recommendation module 112 can be implemented in software, in hardware, or as a combination of software and hardware components. In this example, the title recommendation module 112 is implemented as a software application or module, such as executable software instructions (e.g., computer-executable instructions) that are executable with a processor system (e.g., processor 104) of the mobile device 102 to implement the techniques and features described herein. As a software application or module, the title recommendation module 112 can be stored on computer-readable storage memory (e.g., memory 106), or in any other suitable memory device or electronic data storage. Alternatively or in addition, the title recommendation module 112 is implemented in firmware and/or at least partially in computer hardware. For example, at least part of the title recommendation module 112 is executable by a computer processor, and/or at least part of the title recommendation module is implemented in logic circuitry.

In this example system 100, the title recommendation module 112 receives a calendar invite with meeting information (e.g., calendar data 114). The meeting information includes one or more of attendees, a title, or an agenda. The title recommendation module 112 includes a natural language processing (NLP) module 116 to recommend an alternative title for the calendar invite based at least on the meeting information. In some implementations, the NLP module 116 may use the interface module 110 to connect to a remote system 118 via the communication network(s) 108 to fetch external data 120 and/or user preferences 122 to provide further context for the alternative title.

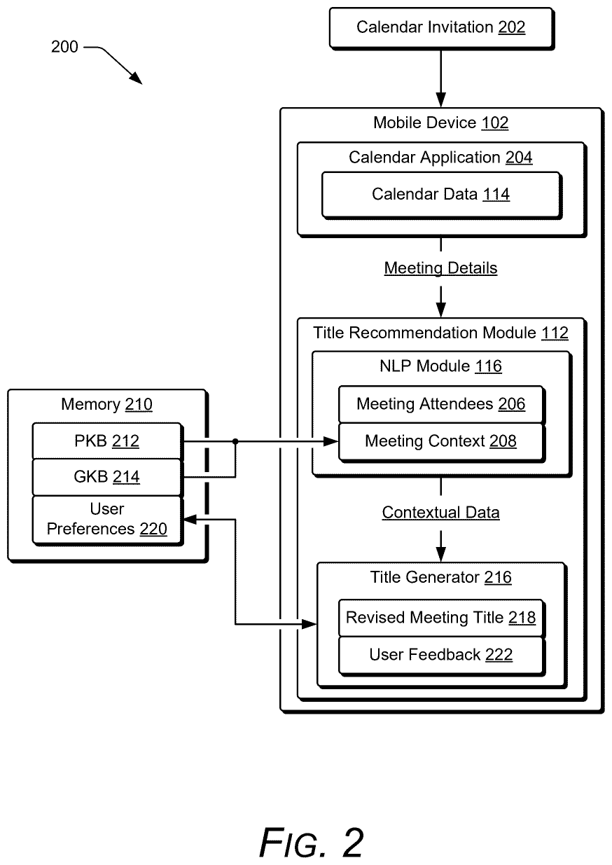

FIG. 2 further illustrates an example system 200 in which aspects of generating contextual titles for calendar invites can be implemented in accordance with one or more implementations as described herein. By way of example, the mobile device 102 receives a calendar invitation 202 for a meeting, event, task, or appointment. The calendar invitation 202 can be received from another user device and directed to the mobile device 102 or forwarded to the mobile device via another user device.

The calendar invitation 202 is integrated with other calendar data 114 associated with a calendar application 204 on the mobile device 102. The calendar application 204 includes a calendar feature integrated into an email or communication platform. The calendar application 204 extracts meeting details from the calendar invitation 202 and provides the details to the title recommendation module 112, which includes the NLP module 116. The extracted meeting details include meeting attendees 206, titles, locations, and/or agendas.

The NLP module 116 analyzes the meeting details to identify a meeting context 208, which includes key topics or themes, using semantic analysis and entity recognition. Semantic analysis interprets the underlying meaning of words, sentences, and documents included in the meeting details to identify the meeting's context. For example, word sense disambiguation is used to identify a correct meaning of a word based on its context. The NLP module 116 also determines the sentiment or emotional tone of the meeting details. The NLP module 116 can also access a memory 210 to obtain a personal knowledge base (PKB) 212 associated with the user and a general knowledge base (GKB) 214 to refine the identified meeting context 208. The memory 210 can be included in the mobile device 102 or be remote to the mobile device 102.

For example, the PKB 212 includes demographic information (e.g., age, gender, location, etc.), interests and preferences (e.g., hobbies, favorite topics, preferred content formats), behavioral data (e.g., browsing history, purchase history, social media activity, past requests), feedback data (e.g., explicit or implicit feedback on products, services, or content), and/or personal knowledge (e.g., calendars, user-generated content, notes, bookmarks, etc.) for one or more users associated with the mobile device 102. In other implementations, the PKB 212 or a portion thereof (e.g., containing sensitive information) is stored in a secure element, which may be separate from the general memory of the mobile device 102. For example, the secure element can be an embedded secure element (eSE), which is a tamper-resistant hardware device, such as a smart card chip that includes its own integrated processor, memory (e.g., ROM, EEPROM, RAM), and an I/O port for tamper-proof connectivity and data communication with other hardware devices implemented in the mobile device 102.

The GKB 214 includes general information and knowledge usable by the NLP module 116 to refine the context analysis further. The NLP module 116 provides the contextual data to a title generator 216 to suggest a revised meeting title 218 for the calendar invitation 202. In addition to the contextual details, the title generator 216 can use user preferences 220 (e.g., explicitly provided by the user or implicitly learned based on historical context as part of user feedback 222) to generate the revised meeting title 218. The user preferences 220 can include naming conventions for meetings and preferred references and words for certain topics.

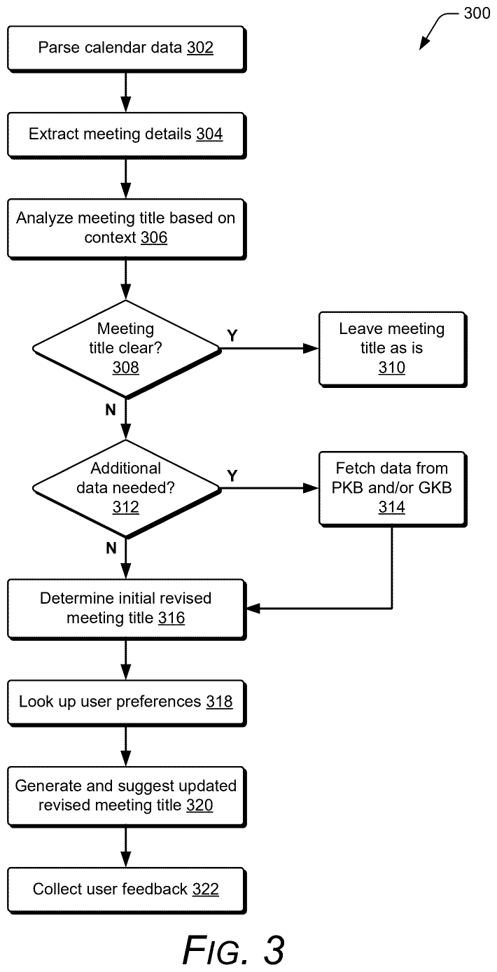

FIG. 3 illustrates an example flow diagram 300 in which aspects of generating contextual titles for calendar invites can be implemented. Generally, any services, components, modules, managers, controllers, methods, and/or operations described herein can be implemented using software, firmware, hardware (e.g., fixed logic circuitry), manual processing, or any combination thereof. Some operations of the example flow diagram may be described in the general context of executable instructions stored on computer-readable storage memory that is local and/or remote to a computer processing system, and implementations can include software applications, programs, functions, and the like. Alternatively, or in addition, any of the functionality described herein can be performed, at least in part, by one or more hardware logic components, such as, and without limitation, field-programmable gate arrays (FPGAs), application-specific integrated circuits (ASICs), application-specific standard products (ASSPs), system-on-a-chip systems (SoCs), complex programmable logic devices (CPLDs), and the like.

The order in which the flow diagram 300 is described is not intended to be construed as a limitation, and any number or combination of the described operations may be performed in any order to perform a procedure, or an alternate procedure.

At 302, calendar data is parsed. By way of example, the calendar application 204 parses a new or existing meeting, task, or event invitation or item in a user's calendar. In other implementations, the calendar application 204 is integrated in or a portion of an email application, a messaging application, a collaboration application, or another application for organizing and managing a user's events, emails, documents, and/or correspondence. The calendar data 114 can be parsed upon creation or reception from another user. In another implementation, the calendar data 114 is parsed and analyzed for improved titles in response to a user selection of a title recommendation task or calendar-period preparation (e.g., “get me ready for tomorrow/next week” feature).

At 304, meeting details are extracted from the calendar data. By way of example, the calendar application 204 extracts meeting details, which includes one or more of meeting titles, attendees, locations, and agendas from the calendar data 114.

At 306, the meeting title is analyzed based on the context. By way of example, the title recommendation module 112 uses the NLP module 116 to analyze the meeting title in view of the other meeting details and meeting's context. The NLP module 116 processes the meeting details to determine a context for the meeting (or other calendar items) and identify key topics and themes for the meeting.

At 308, it is determined whether the meeting title is clear. By way of example, the NLP module 116 determines whether the meeting title is clear in terms of the identified context. In one implementation, the NLP module 116 classifies the current meeting title as “clear” or “not clear.” In another implementation, the NLP module 116 generates a clarity score or confidence metric associated with the current meeting title being sufficiently clear. If the clarity score or confidence metric is below a predetermined or user-adapted threshold value (e.g., eighty percent), the NLP module 116 proceeds with a determination that the meeting title is not sufficiently clear.

At 310, and in response to a determination that the meeting title is clear (e.g., a “yes” or “Y” determination at block 308), the title recommendation module 112 leaves the meeting title as is without recommending an updated or new title.

At 312, and in response to a determination that the meeting title is not clear (e.g., a “no” or “N” determination at block 308), the title recommendation module 112 determines whether new or additional data is needed to generate a new or updated title. By way of example, the NLP module 116 determines whether the meeting details include sufficient details to identify the context and key topics or whether the meeting is similar to a previous calendar event processed by the title recommendation module 112. In one implementation, the NLP module 116 classifies the initial context, topics, and themes as “clear” or “not clear.” In another implementation, the NLP module 116 generates a confidence metric associated with the current context being sufficiently clear. If the confidence metric is below a predetermined or user-adapted threshold value (e.g., eighty percent), the NLP module 116 proceeds with a determination that additional data is needed.

At 314, and in response to a determination that additional data is needed (e.g., a “yes” or “Y” determination at block 312), the title recommendation module 112 fetches additional data from a personal knowledge base associated with the user and/or a general knowledge base. By way of example, the title recommendation module 112 collects data indicating the user's history and involvement with the identified topic or attendees, the relationships between the attendees and topics, or any organization-specific context from the PKB 212. The PKB 212 can include one or more of the user's emails, chats, documents, and calendar data within the calendar application 204 or other applications. The title recommendation module 112 can also gather information about the attendees, meeting location, and/or identified topics from the GKB 214, which can include information available on the internet or a local intranet.

At 316, and in response to a determination that additional data is not needed (e.g., a “no” or “N” determination at block 312) or in response to fetching additional data (e.g., at block 314), the title recommendation module 112 determines an initial revised meeting title. By way of example, the NLP module 116 determines an initial recommendation for revising or updating the meeting title based on the context analysis described above. In one implementation, the recommendation is presented as an overlap on a display of the user's calendar or as a separate pop-up box for the user to accept or reject.

At 318, user preferences for meeting titles are looked up. By way of example, the title recommendation module 112 obtains any user preferences 220 associated with meeting title recommendations to further personalize the meeting titles. The user preferences 220 can include naming conventions or preferred references explicitly learned from user feedback or implicitly learned based on historical context.

At 320, an updated revised meeting title is generated and suggested to the user. By way of example, the title recommendation module 112 outputs the meeting title recommendation to the user that incorporates the contextual analysis and any user preferences. In one implementation, blocks 318 (e.g., looking up user preferences) precedes block 316 and blocks 316 and 320 are integrated into a single step or output of the NLP module 116. The meeting title recommendations can be made on demand or dynamically in real time, with or without explicit user acceptance. In one implementation, the meeting title is replaced with the suggested meeting title in response to the user accepting the recommendation. In this or another implementation, the previous meeting title is saved so the user can recall the original meeting title or if the user did not expressly accept the recommendation.

At 322, the title recommendation module 112 collects user feedback to optimize the NLP module 116 or update the PKB 212 and/or the user preferences 220. As described above, the user feedback can be received through explicit requests or implicitly through user action or inaction in response to the recommendations.

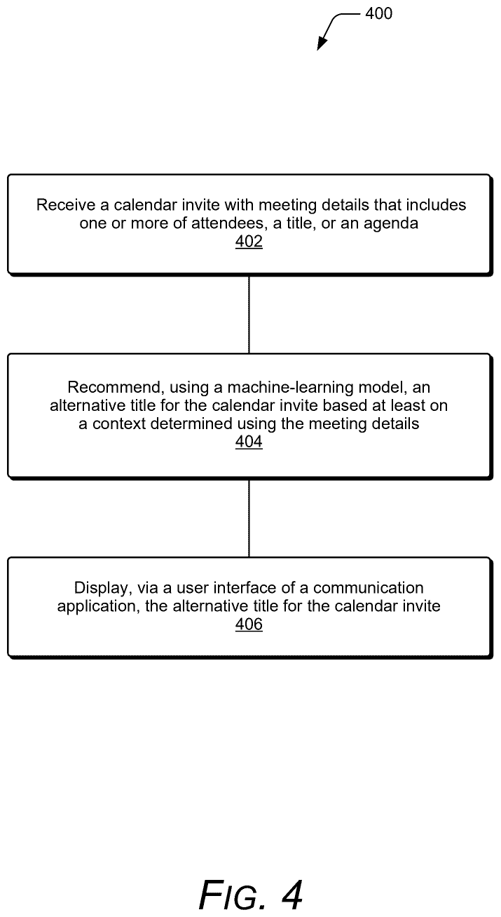

FIG. 4 illustrates an example method 400 for generating contextual titles for calendar invites in accordance with one or more implementations of the techniques described herein. Generally, any services, components, modules, managers, controllers, methods, and/or operations described herein can be implemented using software, firmware, hardware (e.g., fixed logic circuitry), manual processing, or any combination thereof. Some operations of the example method may be described in the general context of executable instructions stored on computer-readable storage memory that is local and/or remote to a computer processing system, and implementations can include software applications, programs, functions, and the like. Alternatively, or in addition, any of the functionality described herein can be performed, at least in part, by one or more hardware logic components, such as, and without limitation, field-programmable gate arrays (FPGAs), application-specific integrated circuits (ASICs), application-specific standard products (ASSPs), system-on-a-chip systems (SoCs), complex programmable logic devices (CPLDs), and the like.

The order in which the method 400 is described is not intended to be construed as a limitation, and any number or combination of the described operations may be performed in any order to perform a method, or an alternate method.

At 402, a calendar invite with meeting details is received. The meeting details can include one or more of attendees, a title, or an agenda. By way of example, the calendar invitation 202 is received via a communication or organization application (e.g., the calendar application 204). In another implementation, the title recommendation module 112 is prompted to analyze the user's calendar data for potential title recommendations. The generation of an alternative title for calendar invites can be performed in response to a user request (e.g., on demand) or automatically in response to receive a new calendar invite.

At 404, an alternative title for the calendar invite is recommended using a machine-learning model and based at least on a context associated with the meeting details. By way of example, the NLP module 116 uses natural language processing techniques on the meeting details to determine the context associated with the calendar invitation 202. The NLP module 116 can also use emails, chats, documents, past calendar invites, the PKB 212, and/or the GKB 214 to refine the context associated with the calendar invite. The alternative title can also be based on user preferences, which include one or more of the preferred naming conventions for particular contexts or preferred wordings for a topic associated with the invitation's context.

At 406, the alternative title for the calendar invite is displayed via a user interface of a communication application. By way of example, the title recommendation module 112 causes the alternative title to be displayed in a user interface associated with the user's calendar data 114. The title recommendation module 112 can also request user feedback on the alternative title to optimize the NLP module 116 for future title recommendations or to save as a user preference.

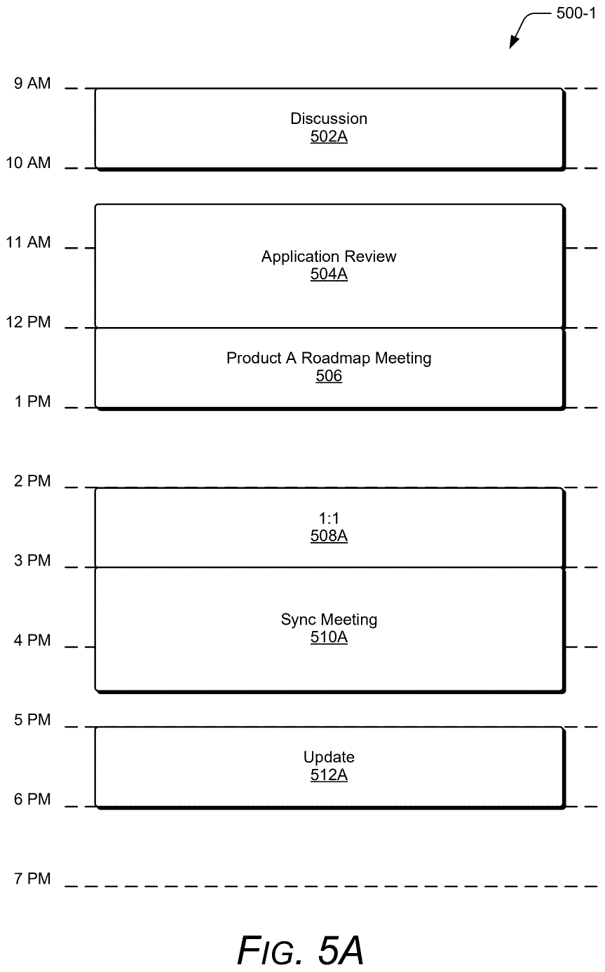

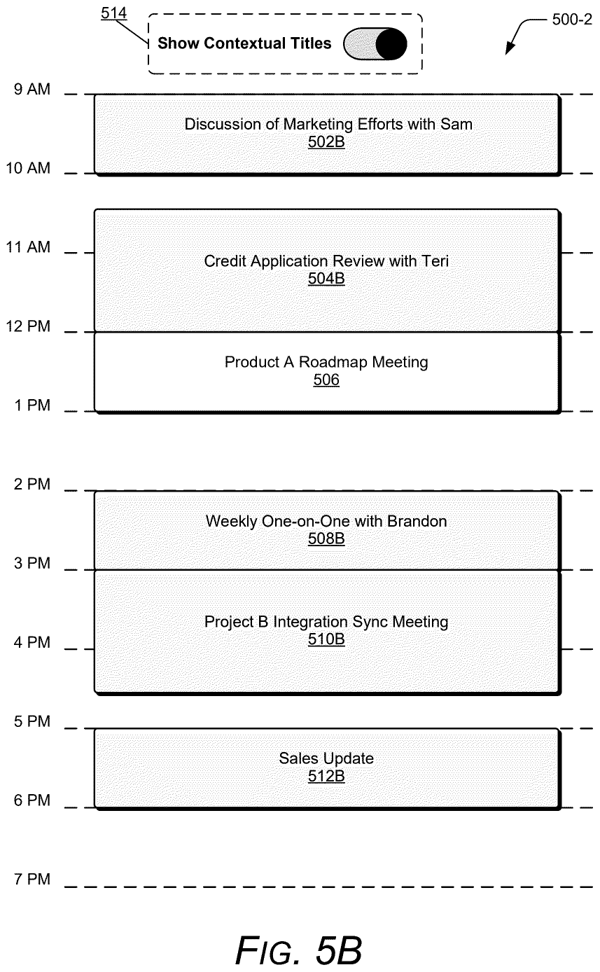

FIGS. 5A and 5B illustrate example user interfaces 500-1 and 500-2, respectively, with calendar invites in which aspects of generating contextual titles for calendar invites can be implemented.

User interface 500-1 in FIG. 5A illustrates an example view of a user's calendar for a workday. The calendar includes six scheduled meetings, with the user interface 500-1 providing a preview of the meeting title and an indication of the meeting's duration. For example, the user has a “Discussion” 502A at 9 am, an “Application Review” 504A at 10:30 am, a “Product A Roadmap Meeting” 506 at noon, a “1:1” 508A at 2 pm, a “Sync Meeting” 510A at 3 pm, and an “Update” 512A at 5 pm. The user interface 500-1 displays the original titles for each calendar invite. As illustrated, many of these meetings (e.g., meetings 502A, 504A, 508A, 510A, and 512A) have ambiguous and confusing names that do not provide an indication of the meeting's purpose. In response to these calendar invites, the user likely opens each meeting individually to better understand the meeting's purpose and determine whether any additional preparation is needed.

User interface 500-2 in FIG. 5B illustrates an example view of the user's calendar for the same workday with contextual titles in accordance with aspects of the techniques and features described herein. In this scenario, the user interface 500-2 includes a user interface (UI) element 514, allowing the user to enable the “show contextual titles” feature in the example calendar application. In this scenario, the user has enabled contextual titles to be displayed in user interface 500-2 by activating or turning on the UI element 514. The title recommendation module 112 clears the confusing and ambiguous titles associated with meetings 502A, 504A, 508A, 510A, and 512A and displays contextual titles for each of these meetings in accordance with the techniques and features described with reference to FIGS. 1 through 4. For example, the user interface 500-2 now shows that the user has a “Discussion of Marketing Efforts with Sam” 502B at 9 am, a “Credit Application Review with Teri” 504B at 10:30 am, a “Product A Roadmap Meeting” 506 at noon, a “Weekly One-on-One with Brandon” 508B at 2 pm, a “Project B Integration Sync Meeting” 510B at 3 pm, and a “Sales Update” 512B at 5 pm. The user interface 500-2 also includes a highlighting or different background color for each meeting that has a contextual title added. In other implementations, the user interface 500-2 may use alternative means to indicate which calendar invites have contextual titles added by using a different font, style, or color for the meeting title, displaying the previous title stricken out, or including an icon (e.g., an asterisk) near the contextual title. In alternative implementations, the user interface 500-2 may use different UI elements to allow the user to enable contextual titles or the contextual titles may be automatically generated.

FIG. 6 illustrates various components of an example device 600, which can implement aspects of the techniques and features for contextual titles for calendar invites, as described herein. The example device 600 may be implemented as any of the devices described with reference to the previous FIGS. 1-5, such as any type of a wireless device, mobile device, mobile phone, flip phone, client device, companion device, display device, tablet, computing, communication, entertainment, gaming, media playback, and/or any other type of computing and/or electronic device. For example, the mobile device 102 described with reference to FIGS. 1-5 may be implemented as the example device 600.

The example device 600 can include various, different communication devices 602 that enable wired and/or wireless communication of device data 604 with other devices. The device data 604 can include any of the various device data and content that is generated, processed, determined, received, stored, and/or communicated from one computing device to another. Generally, the device data 604 can include any form of audio, video, image, graphics, and/or electronic data generated by applications executing on a device. The communication devices 602 can also include transceivers for cellular phone communication and/or for any type of network data communication.

The example device 600 can also include various and different types of data input/output (I/O) interfaces 606, such as data network interfaces that provide connection and/or communication links between the devices, data networks, and other devices. The data I/O interfaces 606 may be used to couple the device to any type of components, peripherals, and/or accessory devices, such as a computer input device that may be integrated with the example device 600. The I/O interfaces 606 may also include data input ports via which any type of data, information, media content, communications, messages, and/or inputs may be received, such as user inputs to the device, as well as any type of audio, video, image, graphics, and/or electronic data received from any content and/or data source.

The example device 600 includes a processor system 608 of one or more processors (e.g., any of microprocessors, controllers, and the like) and/or a processor and memory system implemented as a system-on-chip (SoC) that processes computer-executable instructions. The processor system 608 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits 610. The example device 600 may also include any type of a system bus or other data and command transfer system that couples the various components within the device. A system bus can include any one or combination of different bus structures and architectures, as well as control and data lines.

The example device 600 also includes memory and/or memory devices 612 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 612 include volatile memory and non-volatile memory, fixed and removable media devices, and any suitable memory device or electronic data storage that maintains data for computing device access. The memory devices 612 can include various implementations of random-access memory (RAM), read-only memory (ROM), flash memory, and other types of storage media in various memory device configurations. The example device 600 may also include a mass storage media device.

Memory devices 612 (e.g., computer-readable storage memory) provide data storage mechanisms, such as storing device data 604, other types of information and/or electronic data, and various device applications 614 (e.g., software applications and/or modules). For example, an operating system 616 may be maintained as software instructions with a memory device 612 and executed by the processor system 608 as a software application. The device applications 614 may also include a device manager, such as any form of a control application, software application, signal-processing and control module, code specific to a particular device, a hardware abstraction layer for a particular device, and so on.

In this example, the device 600 includes a title recommendation module 618 that implements various aspects of the features and techniques described herein. The title recommendation module 618 may be implemented with hardware components and/or in software as one of the device applications 614, such as when the example device 600 is implemented as the mobile device 102 described with reference to FIGS. 1-5. An example of the title recommendation module 618 is the title recommendation module 112 implemented by the mobile device 102, such as a software application and/or as hardware components in the mobile device. In implementations, the title recommendation module 618 may include independent processing, memory, and logic components as a computing and/or electronic device integrated with the example device 600.

The example device 600 can also include a microphone 620 (e.g., to capture audio and/or an audio recording) and/or camera devices 622 (e.g., to capture digital images and/or video images), as well as device sensors 624, such as may be implemented as components of an inertial measurement unit (IMU). The device sensors 624 may be implemented with various sensors, such as a gyroscope, an accelerometer, and/or other types of motion sensors to sense the motion of the device. The device sensors 624 can generate sensor data vectors having three-dimensional parameters (e.g., rotational vectors in x, y, and z-axis coordinates) indicating location, position, acceleration, rotational speed, and/or orientation of the device. The example device 600 can also include one or more power sources 626, such as when the device is implemented as a wireless device and/or a mobile device. The power sources may include a charging and/or power system, and may be implemented as a flexible strip battery, a rechargeable battery, a charged super-capacitor, and/or any other type of active or passive power source.

The example device 600 can also include an audio and/or video processing system 628 that generates audio data for an audio system 630 and/or generates display data for a display system 632. The audio system 630 and/or the display system 632 may include any types of devices or modules that generate, process, display, and/or otherwise render audio, video, display, and/or image data. Display data and audio signals may be communicated to an audio component and/or to a display component via any type of audio and/or video connection or data link. In implementations, the audio system 630 and/or the display system 632 are integrated components of the example device 600. Alternatively, the audio system 630 and/or the display system 632 are external, peripheral components to the example device.

Although implementations for contextual titles for calendar invites have been described in language specific to features and/or methods, the appended claims are not necessarily limited to the specific features or methods described. Rather, the specific features and methods are disclosed as example implementations for contextual titles for calendar invites, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device comprising at least one memory to maintain calendar data, and at least one processor coupled with the at least one memory and configured to cause the mobile device to receive a calendar invite of the calendar data with meeting details that include one or more of attendees, a title, or an agenda, determine, using a machine-learning model and based at least on a context determined using the meeting details, an alternative title for the calendar invite, and display, via a user interface, the alternative title.

A mobile device wherein the machine-learning model uses natural language processing techniques on the meeting details to determine the context associated with the calendar invite.

A mobile device wherein the machine-learning model also uses one or more of emails, chats, documents, or past calendar invites to refine the context associated with the calendar invite.

A mobile device wherein the machine-learning model also uses a personal knowledge base associated with a user of the mobile device to refine the context associated with the calendar invite.

A mobile device wherein the personal knowledge base includes one or more of a relationship between the user and the attendees, a role of the user within an organization associated with the calendar invite, or a history of the user with the context.

A mobile device wherein the at least one processor is further configured to cause the mobile device to request user feedback on the alternative title to optimize the machine-learning model.

A mobile device wherein the at least one processor is further configured to cause the mobile device to determine the alternative title based on user preferences that include one or more of a naming convention for the context or a preferred wording for a topic associated with the context.

A mobile device wherein the at least one processor is further configured to cause the mobile device to determine the alternative title in response to a user request or automatically in response to receiving the calendar invite.

Alternatively, or in addition to the above-described mobile device, any one or combination of:

A method comprising receiving a calendar invite with meeting details that include one or more of attendees, a title, or an agenda, determining, using a machine-learning model and based at least on a context determined using the meeting details, an alternative title for the calendar invite, and displaying, via a user interface, the alternative title.

A method wherein the machine-learning model uses natural language processing techniques on the meeting details to determine the context associated with the calendar invite.

A method wherein the machine-learning model also uses one or more of emails, chats, documents, or past calendar invites to refine the context associated with the calendar invite.

A method wherein the machine-learning model also uses a personal knowledge base associated with a user to refine the context associated with the calendar invite.

A method wherein the personal knowledge base includes one or more of a relationship between the user and the attendees, a role of the user within an organization associated with the calendar invite, or a history of the user with the context.

A method that further comprises requesting user feedback on the alternative title to optimize the machine-learning model.

A method that further comprises determining the alternative title based on user preferences that include one or more of a naming convention for the context or a preferred wording for a topic associated with the context.

A method that further comprises determining the alternative title in response to a user request or automatically in response to receiving the calendar invite.

Alternatively, or in addition to the above-described method, any one or combination of:

A system comprising a memory to maintain calendar data and a processor to receive a calendar invite of the calendar data with meeting details that include one or more of attendees, a title, or an agenda, determine, using a machine-learning model and based at least on a context determined using the meeting details, an alternative title for the calendar invite, and display, via a user interface, the alternative title.

A system wherein the machine-learning model uses natural language processing techniques on the meeting details to determine the context associated with the calendar invite.

A system wherein the machine-learning model also uses one or more of emails, chats, documents, or past calendar invites to refine the context associated with the calendar invite.

A system wherein the processor is further configured to determine the alternative title based on user preferences that include one or more of a naming convention for the context or a preferred wording for a topic associated with the context.

1. A mobile device, comprising:
at least one memory to maintain calendar data; and
at least one processor coupled with the at least one memory and configured to cause the mobile device to:
receive a calendar invite of the calendar data with meeting details that include one or more of attendees, a title, or an agenda;
determine, using a machine-learning model and based at least on a context determined using the meeting details, an alternative title for the calendar invite; and
display, via a user interface, the alternative title.

2. The mobile device of claim 1, wherein the machine-learning model uses natural language processing techniques on the meeting details to determine the context associated with the calendar invite.

3. The mobile device of claim 2, wherein the machine-learning model uses one or more of emails, chats, documents, or past calendar invites to refine the context associated with the calendar invite.

4. The mobile device of claim 2, wherein the machine-learning model uses a personal knowledge base associated with a user of the mobile device to refine the context associated with the calendar invite.

5. The mobile device of claim 4, wherein the personal knowledge base includes one or more of a relationship between the user and the attendees, a role of the user within an organization associated with the calendar invite, or a history of the user with the context.

6. The mobile device of claim 2, wherein the at least one processor is further configured to cause the mobile device to request user feedback on the alternative title to optimize the machine-learning model.

7. The mobile device of claim 2, wherein the at least one processor is further configured to cause the mobile device to determine the alternative title based on user preferences that include one or more of a naming convention for the context or a preferred wording for a topic associated with the context.

8. The mobile device of claim 1, wherein the at least one processor is further configured to cause the mobile device to determine the alternative title in response to a user request or automatically in response to receiving the calendar invite.

9. A method, comprising:
receiving a calendar invite with meeting details that include one or more of attendees, a title, or an agenda;
determining, using a machine-learning model and based at least on a context determined using the meeting details, an alternative title for the calendar invite; and
displaying, via a user interface, the alternative title.

10. The method of claim 9, wherein the machine-learning model uses natural language processing techniques on the meeting details to determine the context associated with the calendar invite.

11. The method of claim 10, wherein the machine-learning model uses one or more of emails, chats, documents, or past calendar invites to refine the context associated with the calendar invite.

12. The method of claim 10, wherein the machine-learning model uses a personal knowledge base associated with a user to refine the context associated with the calendar invite.

13. The method of claim 12, wherein the personal knowledge base includes one or more of a relationship between the user and the attendees, a role of the user within an organization associated with the calendar invite, or a history of the user with the context.

14. The method of claim 10, further comprises requesting user feedback on the alternative title to optimize the machine-learning model.

15. The method of claim 10, further comprises determining the alternative title based on user preferences that include one or more of a naming convention for the context or a preferred wording for a topic associated with the context.

16. The method of claim 9, further comprises determining the alternative title in response to a user request or automatically in response to receiving the calendar invite.

17. A system comprising:
a memory to maintain calendar data; and
a processor to:
analyze multiple calendar invites that each include meeting details of two or more of attendees, a title, or an agenda;
determine, using a machine-learning model and based at least on a context determined from the meeting details, alternative titles for the multiple calendar invites; and
overlay, via a user interface, the alternative titles in a user interface displaying the calendar data.

18. The system of claim 17, wherein the machine-learning model uses natural language processing techniques on the meeting details to determine the context associated with the multiple calendar invites.

19. The system of claim 18, wherein the machine-learning model uses one or more of emails, chats, documents, or past calendar invites to refine the context associated with the multiple calendar invites.

20. The system of claim 18, wherein the processor is further configured to determine the alternative titles based on user preferences that include one or more of a naming convention for the context or a preferred wording for a topic associated with the context.
